(19) United States
(12) Patent Application Publication
(10) Pub. No.: US 2004/0080461 A1
(43) Pub. Date: Apr. 29, 2004

(54) Structure for concealing telecommunication antennas

(76) Inventors: Scott Brady Rothgeb, (US); Kevin Scot Bacon, (US); Robert Lee Swiney JR., (US)

Correspondence Address: HOWREY SIMON ARNOLD & WHITE LLP, 750 BERING DRIVE, HOUSTON, TX, 77057, US

(21) Appl. No.: 10/622,840

(22) Filed: Jul. 18, 2003

Related U.S. Application Data
(60) Provisional application No. 60/396,882, filed on Jul. 18, 2002.

(51) Int. Cl. H01Q 1/00

(52) U.S. Cl. 343/720

(57) ABSTRACT

A structure for concealing and/or camouflaging emitters and/or receivers of electromagnetic radiation such as, for example, telecommunication antennas is disclosed. The structure may be formed from a panel comprising a light weight, substantially RF transparent poly-vinyl-chloride (“PVC”) foam material. The structure can be fabricated in many ways and in different configurations to hide a variety of telecommunication antennas such as, for example, cellular, omni, and PCS antennas. The structure can be used in varying configurations and sizes. Configurations of the structure can be glued, bolted, and or screwed to itself or other substrates that do not impede RF signals while maintaining different overall appearances, textures, and shapes to hide or camouflage the emitters and/or receivers of electromagnetic radiation.

### CROSS-REFERENCE TO RELATED APPLICATIONS

This application claims the benefit of U.S. Provisional Application Ser. No. 60/396,882, filed Jul. 18, 2002, which is incorporated herein by reference in its entirety.

### FIELD OF THE INVENTION

The invention relates generally to concealment and/or camouflage structures formed from a poly-vinyl-chloride (PVC) foam material for concealing transmitters and/or receivers of electromagnetic radiation such as, for example, telecommunication antennas.

### BACKGROUND OF THE INVENTION

As the demand for cellular phones increases, the need for cellular towers must also increase to satisfy new and existing customers. With the build out of infrastructure underway for over 10 years, cellular towers have become an eyesore for many municipalities and homeowners. This has driven carriers to conceal (e.g., hide, camouflage, or disguise) antenna structures and attempt to cause such structures to visually blend in to the surroundings. Concealing the antenna structures has been accomplished using natural and/or artificial structures such as pine and palm trees, cactus, light poles, bell and clock towers, and flagpoles. When pole structures cannot be used, rooftops are consequently acquired and the buildings are screened using a variety of materials to match or blend in with the buildings existing architectural characteristics. Placing antennas within flagpoles has become one accepted approach for carriers to help hide their antennas.

One issue faced with the construction of camoflauge structures is the selection of the appropriate material from which to construct such material. Because camouflage structures are typically used in connection with distinct and separate antenna elements—camouflage structures typically are not integrally formed with the antenna structures—the camouflage structure and the material from which it is formed must generally be selected so as to avoid undue interference with the electromagnetic radiation transmitted and/or received by the antenna. Moreover, because in most applications such concealment structures must be exposed to the environment, the structures and the material from which they are formed must be able to withstand minor impacts, extensive sunlight, rain, snow, etc.

Conventionally, antenna concealment structures are formed from relatively hard, relatively solid materials, which are well known to withstand the environmental conditions described above. Such hard, solid materials include fiberglass, conventional ABS (acrylonitrile butadiene styrene), and common plastic. In certain applications, concealment panels have been formed that comprise an inner core of, for example, closed cell foam such as polystyrene, and a relatively hard outer skin layer formed from ABS. Such a panel is disclosed in U.S. Pat. No. 5,852,424.

In certain applications that typically involve relatively small antenna structures (e.g., of less than one foot in length and/or diameter), relatively hard materials, such as polyvinyl chloride (PVC) plastic in the form of a PVC tube, have been used to conceal such an antenna. In such applications, the PVC is typically described as being a tube or a pipe structure indicating the relatively hard solid nature of the material. For example, U.S. Pat. No. 6,072,984 describes the use of a PVC tube to enclose a cellular antenna, where the tube/antenna assembly has dimensions of twelve inches long and three inches in diameter. In other applications, involving larger antenna structures, the use of PVC for antenna containment structures involves the use of a PVC structure combined with some other material (e.g., acrylic) to form what appears to be a relatively dense structure. For example, U.S. Pat. No. 5,966,102 describes the use of an acrylic PVC alloy sheet to form a radome housing. Similarly, U.S. Pat. No. 5,619,217 discloses an antenna assembly including a plastic cover that is described as being formed from either ABS or PVC.

While ABS and solid PVC materials provide for the construction of durable, substantially weather-resistant structures, it has been discovered that such materials have an attenuating and/or distorting effect on electromagnetic radiation signals and, in particular, on RF signals passing through the ABS or solid PVC material. Such attenuation/distortion is undesirable as it may interfere with the proper functioning of the antenna concealed by the ABS or PVC containing structure. The attenuation/distortion is related to the relatively high dielectric constant of such materials. As is known, the dielectric constant of a material is a measure of the ability of electromagnetic signals to readily pass through the material. In general, air has a relative dielectric constant of approximately 1 and materials with relative dielectric constants of greater than one have a higher resistance to the transmission of electromagnetic signals than air. As reported by the ASI Instruments, Inc. Dielectric Constant Reference Guide, available as of Jul. 18, 2002 at <http://www.asiinstr.com>, the dielectric constant of ABS, Resin (Lump) is 2.4 to 4.1, the dielectric constant of ABS Resin (Pellet) is 1.5 to 2.5, the dielectric constant for polyvinyl chloride is 3.4, and the dielectric constant for polyvinylchloride resin is between 5.8 to 6.8.

The concealment structure and method of assembling the same described herein overcomes the above-described and other problems and limitations of conventional structures.

### SUMMARY OF THE DISCLOSURE

In accordance with one exemplary embodiment of the present invention, a concealment panel for an antenna structure includes a center core of foam composed of, for example, polystyrene, with sheets of expanded poly-vinyl-chloride (PVC) foam disposed on either side of the foam core. The expanded PVC sheets are disposed on the foam core so that they form a groove at one end and allow an exposed tongue of the foam core to extend from the other end of the panel. This tongue and groove arrangement provides a convenient way to affix multiple panels together for constructing a concealment structure

In accordance with a further exemplary embodiment of the present invention, a sheet of expanded PVC foam is thermoformed or vacuum formed into a substantially half-cylinder shape. Two of these substantially half-cylinder panels are then bolted together to form a substantially cylindrical concealment structure that resembles, for example, a flag pole.

### BRIEF DESCRIPTION OF THE DRAWINGS

The foregoing summary, preferred embodiments, and other aspects of subject matter of the present disclosure will be best understood with reference to a detailed description, which follows, when read in conjunction with the accompanying drawings, in which:

FIGS. 1A through 1C illustrates an embodiment of a concealment panel comprising a foam core with expanded PVC foam sheets disposed on opposite surfaces of the core and forming a tongue and groove system for attaching a plurality of such concealment panels to each other.

FIGS. 2A through 3B illustrate another embodiment of a concealment panel and a technique for connecting concealment panels using biscuits.

FIGS. 3A through 3C illustrate another technique for connecting concealment panels using connecting brackets.

FIGS. 4A through 4B illustrate a concealment structure formed from a sheet of expanded PVC foam formed into a generally cylindrical shape for use as a flag pole, for example.

FIGS. 5 through 9 illustrate various views of a flag pole structure having concealment panels and other assembly components according to certain teachings of the present disclosure.

While the subject matter of the present disclosure is susceptible to various modifications and alternative forms, specific embodiments have been shown by way of example in the drawings and are herein described in detail. The figures and written description are not intended to limit the scope of the inventive concepts in any manner. Rather, the figures and written description are provided to illustrate the inventive concepts to any person skilled in the art by reference to particular embodiments, as required by 35 U.S.C. § 112.

### DETAILED DESCRIPTION

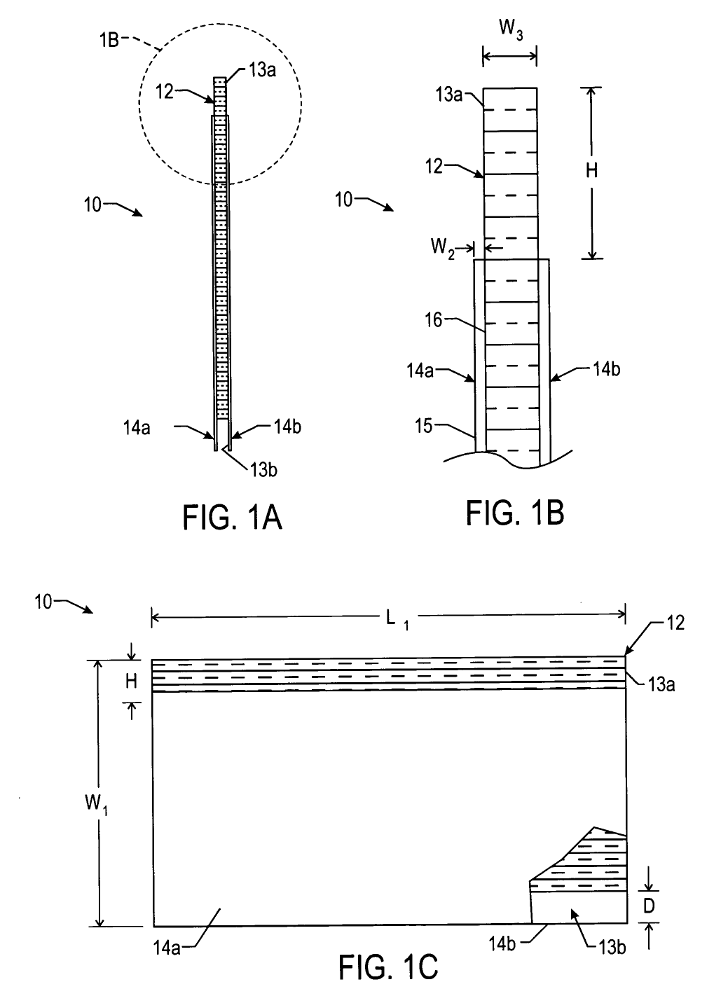

Turning to the drawings and, in particular, to FIGS. 1A-1C, a first embodiment of a concealment structure for use with transmitters and/or receivers of electromagnetic waves is illustrated. Although the present description will focus on an exemplary use of such a structure in connection with telecommunication antennas, it should be understood that the teachings of this disclosure are applicable to varying forms of transmitters and/or receivers of electromagnetic waves and may be used, for example, on other forms of transmitters/receivers, such as microwave devices, very high frequency (VHF) or ultrahigh frequency (UHF) devices, cellular, PCS, point-to-point service providers, and omni antennas. The described structure may also be used to conceal transmitting and receiving devices intended for short length transmissions, such as wireless internet devices and Bluetooth devices.

In general, the concealment structure comprises a generally rectangular panel 10 having dimensions sufficient to enable the construction of an antenna concealment structure sufficiently large to conceal a telecommunications antenna or antenna system. In the exemplary embodiment and as best shown in FIG. 1C, the panel 10 has a width W₁ of approximately four feet and an length L₁ of approximately eight feet (4′×8′), although alternate embodiments with dimensions of, for example, 4×10′ and 4′×12′ are envisioned. The panel 10 is laminated and is formed from a foam core 12 positioned between two sheets 14a and 14b formed of an expanded foam PVC material. The foam core 12 may be formed from any suitable foam material such as, for example, polystyrene. A suitable material may be obtained from the Dow Chemical Company in the form of Load 40 Extruded Foam Insulation. While the dimensions of the foam core 12 will vary from application to application, the foam core 12 in the illustrated embodiment is two inches thick, four feet in width, and eight feet in length. Although the present embodiment includes a panel 10 having a foam core 12 positioned between two sheets 14a and 14b, alternative embodiments of a panel could include a foam core 12 with only one sheet of expanded foam PVC attached.

In the illustrated example, the foam core 12 is positioned between the sheets 14a and 14b in an offset fashion such that an approximately four inch high H “tongue” portion 13a of the foam core 12 is exposed along one edge of the panel 10 and a four inch deep D “groove” portion 13b is established along the opposing edge of the panel 10. The construction of the tongue portion 13a and groove portion 13b provides a ready means of coupling multiple panels 10 together by fitting a tongue portion 13a of one panel 10 into the groove portion 13b in another panel 10. Typically, glue, caulk, or other adhesive may be used to adhere the coupling of the tongue portion 13a to the groove portion 13b.

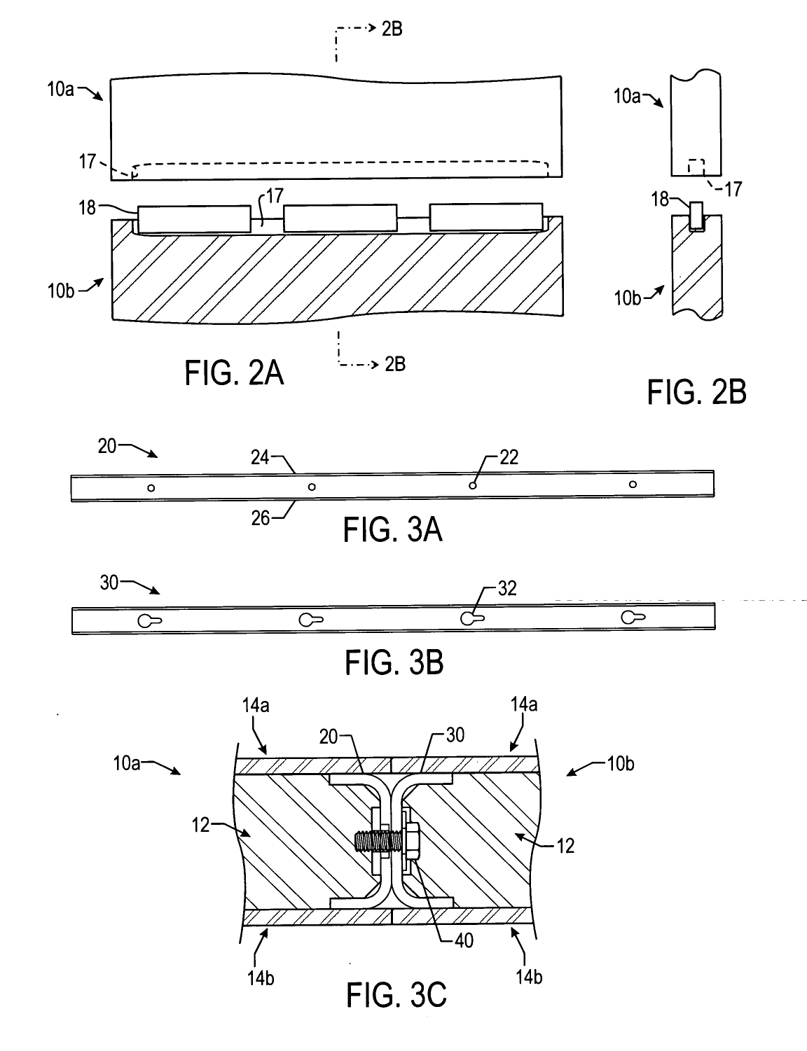

Alternate embodiments are envisioned whether the foam core 12 is positioned flush with the sheets 14a and 14b such that there are no exposed core sections. In such embodiments, glue, brackets, biscuits, and other techniques may be used to couple multiple core segments to one another. When biscuits are used, such as disclosed in more detail in FIGS. 2A through 2B, the biscuits may be formed of wood, PVC, expanded PVC foam, or fiberglass. For a panel having the dimensions of the panel 10 of FIGS. 1A-1C, biscuits having a size of approximately 10-mm thickness by one foot in length may be used to connect the panels together.

It has been discovered that the use of expanded foam PVC to form the sheets 14a and 14b on the panel 10 for a concealment structure of multiple panels provides for a level of product durability and electromagnetic radiation transparency that has not been available from concealment structures formed from conventional materials (e.g., ABS or non-expanded, non-foam PVC material). Moreover, it has been found that expanded PVC material has a strength sufficient to withstand the loads that exist for concealment structures of a size sufficient to conceal standard telecommunication antenna assemblies. For example in a flagpole-type structure, the use of expanded PVC foam material with a thickness of 10 mm has been found sufficient to withstand winds forces of 125 m.p.h.

In the example of FIGS. 1A-1C, each of the sheets 14a and 14b is formed form an expanded PVC foam material. The expanded PVC foam material may be a suitable PVC foam material formed, for example, by entraining air or another suitable gas into a PVC compound such that a relatively light, low density foam material is formed. The expanded PVC foam material will have a dielectric constant that is substantially lower than the dielectric constant for conventional, PVC materials. The precise value of the dielectric constant of the expanded PVC foam material will vary depending on the degree to which the PVC material has been expanded. In general, however, it has been discovered that desired results are obtained when the expansion of the PVC material is controlled such that the dielectric constant of the expanded foam material is equal to two or less and, in one embodiment, is on the order of 1.8. The dielectric constant of the material may be determined according to the procedures of ASTM D-150 at a frequency of 1 kHz.

As best shown in FIG. 1B, the sheets 14a and 14b of expanded PVC foam material preferably have a width W₂ sufficient to protect the foam core 12 from undue damage. While the precise desirable width W₂ will vary from application to application, it has been discovered that a width W₂ for the sheets 14a and 14b between approximately 4-mm and 10-mm is often desirable. The outer portions 15 of the sheets 14a and 14b may be painted or textured to provide various aesthetic or camouflage features and may, for example, reproduce the appearance of a stucco material or brick. Alternately, if the panel 10 is to be used to conceal a structure in a ceiling, the panel 10 may take the form of a ceiling tile.

The composition of the sheets 14a and 14b of expanded PVC foam does not need to be consistent across the width of the sheets 14a and 14b. For example, each sheet 14a and 14b of expanded PVC foam may have an interior core of expanded PVC material and relatively a thin integral hard outer skin surface. To protect against ultraviolet (UV) degradation, the expanded PVC foam may include some form of UV protectant. One suitable material for use in constructing the sheets 14a and 14b is the InteFoam product available from the World-Pak Division of Inteplast Group, Ltd.

In one embodiment of the laminated panel 10, the foam core 12 may be attached to the sheets 14a and 14b using tape. A suitable tape for the panel 10 is manufactured by 3M, which has product No. 3m 964 and comes in a 24″ wide role. To connect a sheet 14a to the core 12, the tape is applied onto substantially the entire surface of the sheet 14a or the core 12, and the two are then pressed together. The adhesion is then allowed to cure over time with pressure applied. In another embodiment of the laminated panel 10, the core 12 may be attached to the sheets 14a and 14b with any suitable adhesive. It has been discovered that urethane adhesives are desirable, as they do not significantly interfere with the electromagnet radiation passing through the panel 10. It has been also discovered that the thickness of an adhesive layer 16 must be selected to provide suitable adhesion, yet avoid interfering with the transmitted or received radiation. A thickness for the adhesive layer 16 of between 3 to 10-mils has been found to be desirable for many applications. One suitable urethane adhesive is the LORD 7610 or 7660 urethane adhesive available from the Lord Corporation.

To provide the best adhesion between the sheets 14a and 14b and the foam core 12, it has been found beneficial to roughen the surfaces of the expanded PVC foam sheets 14a and 14b and the foam core 12 to be adhered together. Such surface roughening may be accomplished by using a suitable abrasive material, such as sandpaper, for the expanded PVC foam sheet 14a and 14b and by using a wire brush for the foam core 12.

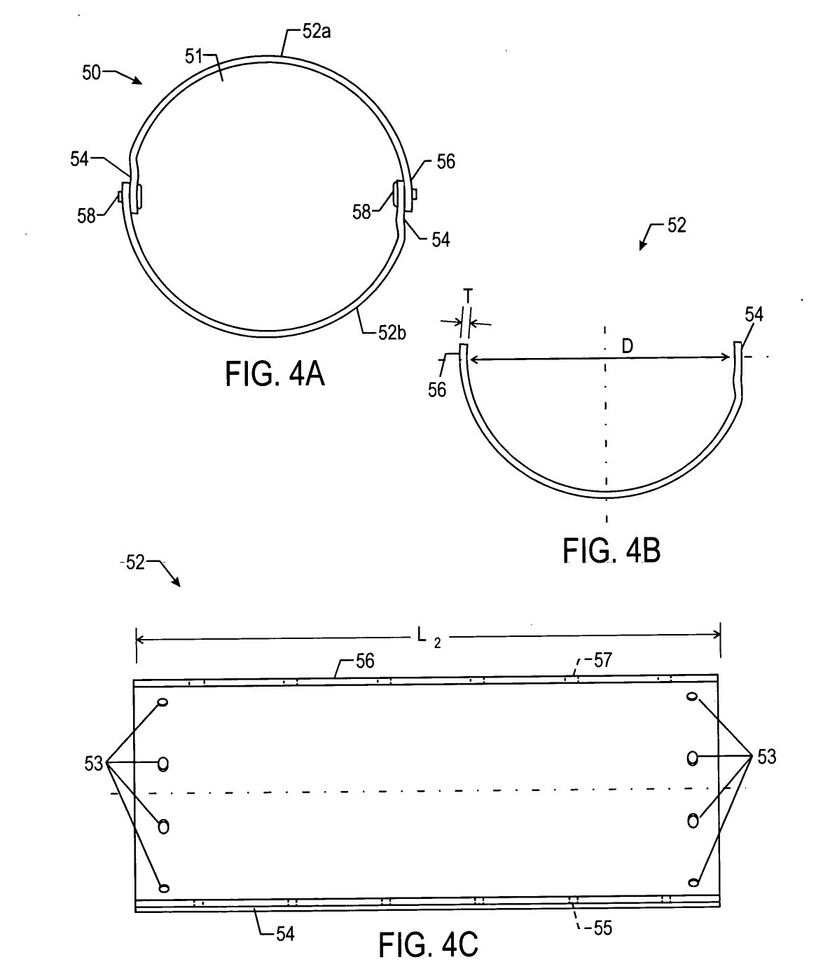

In addition to providing for a structure having a dielectric constant that allows for beneficial transmission of electromagnetic waves and, in particular, RF waves, the use of an expanded PVC foam material in the construction of concealment structures as disclosed herein allows for the construction of concealment structures having a variety of configurations that enhance the ability to hide and/or camouflage structures. Such configurations may involve the use of expanded PVC sheet materials without the use of a foam core. Examples of such embodiments are provided in FIGS. 2A through 2B, which generally illustrates panels composed of a single sheet of expanded PVC sheet and are provided in FIGS. 4A through 4C, which generally illustrate a two-piece radome housing.

Referring to FIGS. 2A through 2B, another embodiment of concealment panels 10a and 10b is illustrated in front and side views. In the present embodiment, the panels 10a and 10b are each formed from a single sheet of expanded PVC foam material. The single sheet of expanded PVC foam material may have a thickness of about 30-mm and may have a width of four feet in width and a length of eight feet, ten feet, or twelve feet, for example. As noted above, glue, brackets, biscuits, and other techniques may be used to couple the panels 10 to one another. In the present embodiment of FIGS. 2A through 2B, one embodiment of a technique for connecting the concealment panels 10a and 10b is illustrated that uses biscuits 18. Ends of the panels 10a and 10b are routed to form central grooves 17. The biscuits 18 may be formed of wood, PVC, expanded PVC foam, or fiberglass, for example. The biscuits 18 are inserted into the central groove 17 of one panel 10a and a caulk is applied to secure the biscuits 18. A suitable caulk material includes NP1™ polyurethane sealant manufactured by Sonneborn Products. Caulk is then applied in the groove 17 of the other panel 10b to be adjoined, and the free ends of the biscuits 18 are then fit into the groove 17 of the other panel 10b to connect the panels. In the illustrated embodiment, three biscuits 18 are shown, but any number and size of biscuits 18 can be used. For example, the biscuits 18 may have a size of approximately 10-mm thickness by one foot in length to connect the panels 110a and 10b.

Referring to FIGS. 3A through 3C, another embodiment of a technique for connecting concealment panels 10a and 10b using connecting brackets 20 and 30 is illustrated. As best shown in FIG. 3A, a first bracket 20 is an elongated strip of material, preferably PVC or ABS, that has a plurality of through holes 22 and has side flanges 24 and 26 along its length. The bracket 20 may be about 4-feet in length and about 2-inches in width, and the through holes 22 may be positioned about every 6-inches along the length of the bracket 20. As best shown in FIG. 3B, a second bracket 30 is also an elongated strip of material, preferably metal, that has a plurality of keyway slots 32 and has side flanges 34 and 36 along its length. The bracket 30 may also be about 4-feet in length and about 2-inches in width, and the keyway slots 32 may be positioned about every 6-inches along the length of the bracket 30.

As best shown in the side view of FIG. 3C, the first bracket 20 is attached to an end of one panel 10a, and the second bracket 30 is attached to an end of another panel 10b. In the present embodiment, the panels 10a and 11b may be substantially similar to those described above in FIGS. 1A-1C having foam cores 12 and side sheets 14a and 14b, although this is not strictly necessary as the brackets 20 and 30 can be used to connect other disclosed embodiments of concealment panels. The brackets 20 and 30 are each fit with their flanges 24, 26 and 34, 36 embedded or installed in the end of the panels 10a and 10b, respectively. For this purpose, the foam cores 12 of the panels 10a and 10b may be cut to create suitable grooves to the brackets 20 and 30. Preferably, the brackets 20 and 30 are affixed to the ends of the panels 10a and 10b with an adhesive or with a caulk, such as NP™. To connect the brackets 20 and 30 together, fasteners 40, preferably made of nylon, are threaded into the through holes 22 of the first brackets 20. Then, the heads of the fasteners 40 are interlocked into the keyway slots 32 of the second bracket 30, and the concealment panels 10a and 10b are connected together.

Referring to FIGS. 4A through 4B, another embodiment of concealment panels 52 is illustrated for forming a radome housing 50. In FIG. 4A, the radome housing 50 is shown in an end view. In the present embodiment, a first, generally semicircular panel 52a and a second, generally semicircular panel 52b are used to form the radome housing 50. The panels 52a and 52b, one of which is shown in a lengthwise view in FIG. 4B, are substantially identical and are designed and shaped such that they may fit together to form the substantially cylindrical radome housing 50. The radome housing 50 can have a diameter D from about 6-inches to 42-inches. Use of only two such panels 52a and 52b is suitable when the diameter D of the radome housing 50 is less than about 28-inches. For a radome housing with the diameter D larger that 28-inches, three or more panels 52 are preferably used.

First edges 54 of each panel 52 form recesses, and second edges 56 form overlaps. As best shown in FIG. 4A, these edges 54 and 56 overlap each other to form a seam when the substantially cylindrical radome housing 50 is formed. Fasteners 58 with washers can be used along the overlapping edges 52 and 54 to connect the vertical seams of the housing 50. The fasteners 58 are preferably made of acrylic or plastic to avoid interference with any electromagnetic radiation to be passed through the housing 50. As best shown in FIG. 4C in which one of the panels 52 is shown lengthwise, the overlap edge 56 of the panel 50 can have slotted holes 57 for the fasteners 58, and the recessed edge 54 can have through holes 55 into which the fasteners 58 can be threaded or press fit, depending on the type of fastener used. At the locations of the through holes 55, plastic threaded members or nuts (not shown) for mating with the fasteners 58 are preferably attached to the inside surface of the panel 50 by heat or solvent welding. The panel 52 may have a length L₂ from about 6-feet to 10-feet, and the holes 55 and 57 can be spaced about every foot along the length L₂. Mounting slots 53, which are preferably elongated to allow for adjustments and fitting, are formed at the ends of the panels 52. Preferably, about four to six mounting slots 53 are formed at each end of the panel 52. Fasteners (not shown), such as conventional bolts and nuts or U-clips, are used to attach to the ends of the panel 52 to attachment plates (not shown) on an antenna mounting spool or other antenna assembly. Metal fasteners can be used at the ends of the panel 52 because issues of interference are of less concern. Although not illustrated, a radome or other antenna assembly, such as an antenna mounting spool, may be placed within the central bore 51 defined by the radome housing 50. The radome housing 50 is particularly useful for creating a flagpole like structure to conceal and/or camouflage antenna assemblies.

In FIG. 4B, the cross sectional dimensions of the semicircular panels 52 is generally illustrated. The panel 52 may be formed by taking a generally flat sheet of expanded PVC foam material having a dielectric constant as described above (i.e., less than 2 and preferably in the vicinity of 1.8) and forming the sheet into the shape depicted in FIGS. 4A through 4C. It has been discovered that a thermoform process may be used to form the panels 52, although other forming processes may be used (e.g., vacuum forming). In general, the dimensions of the sheet before the forming process should be such that the final thickness T of the expanded PVC foam material forming the panel 52 has a thickness of between 4-mm and 10-mm. Because the expanded PVC foam sheet may have a tendency to collapse slightly during a thermoforming or vacuum forming process, the thickness T of the product after forming will often be less than the thickness of the original sheet before forming. In one example, a 10-mm original sheet has been found to collapse to about 4-mm thickness T after thermoforming. In addition, it may be preferred that the panel 52 is thicker in the center than at the edges 54 and 56, which can be accomplished using a convex or male mold during the thermoforming or vacuum forming process.

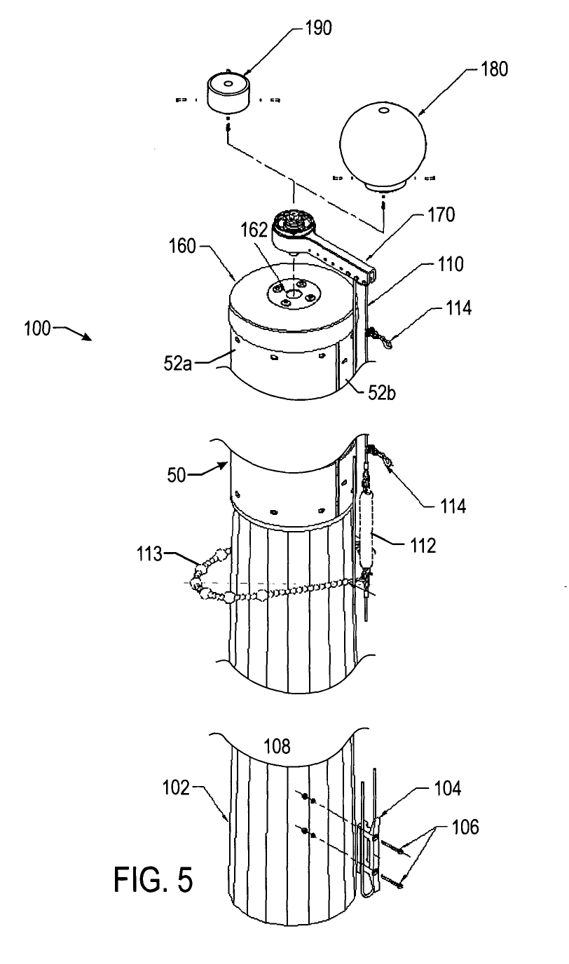

Referring to FIGS. 5 through 9, a flag pole structure 100 using concealment panels and other assembly components according to certain teachings of the present disclosure is illustrated in various views. As best shown in FIG. 5, the flag pole structure 100 includes a support pole 102, a cleat 104, a halyard rope 110, one or more radome housings 50, an end cap 160, and a flag truck assembly 170. In addition, the flag pole structure 100 can include a ball 180 or a truck cap 190. The support pole 102 can be similar to a conventional pole mounted in the ground, foundation, or other structure. The one or more radome housings 50 are mounted above the support pole 102 and form a portion of the flag pole structure 100. In addition, the one or more radome housings 50 conceal and/or camouflage an antenna assembly (not visible in FIG. 5). The end cap 160 is mounted on the end of the last radome housings 50. The flag truck assembly 170 is mounted to the end cap 170, and the ball 180 or truck cap 190 can be mounted onto the flag truck assembly 170. The halyard rope 110 typically has swivel snaps 114 to hold a flag (not shown) and a counter weight 112. The rope 110 is wound through a pulley assembly on an arm of the flag truck assembly 170 and is wound around the cleat 104 attached to the support pole 102 with fasteners 106 and bolts 108.

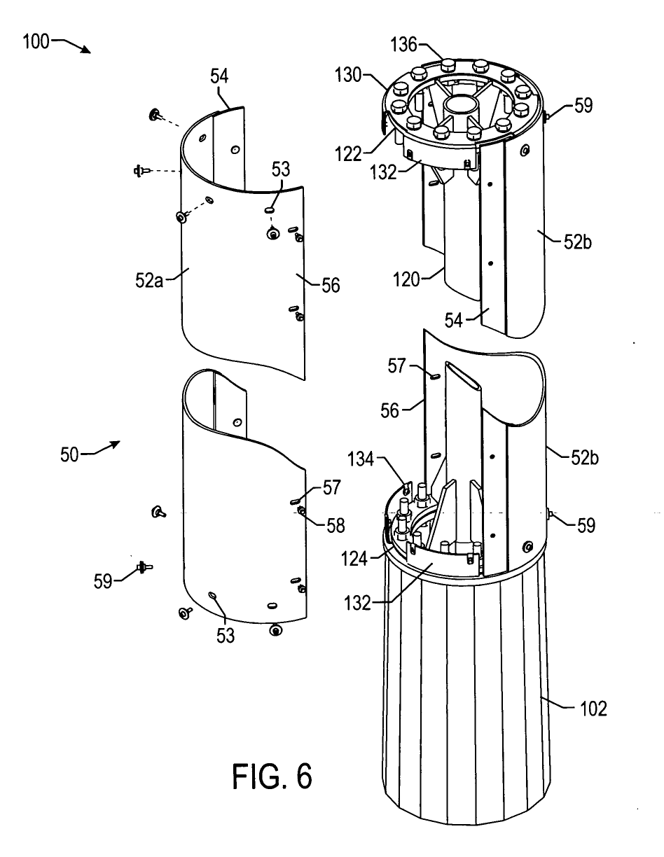

Referring to FIG. 6, the attachment of one radome housing 50 to the support pole 102 and the other assembly components of the flag pole structure 100 is shown in more detail. A mounting pipe or spool 120 for the antenna assembly has a cable opening 122 along its length. Typically, the mounting spool 120 can have antennas, such as PCS or cellular antennas, mounted thereon using antenna brackets known in the art. The mounting spool 120 has flanges 124 at both ends thereof. Preferably, the flanges 122 are attached to the mounting spool 120 with turrets 121, and the flanges 124 typically have opening for the passage of cables. Separate panel mounting rings 130, also having similar opening for the passage of cables, are attached to both flanges 124 with a plurality of bolts 138 and nuts 139. Preferably, about twelve bolts 138 and nuts 139 are used for a flag pole structure 100 having a general diameter of about 28-inches or less. Use of the separate panel mounting rings 130 facilitates assembly. Prior art assembly techniques have required welding of plate to the flanges 124 of the mounting spool 120.

The panel mounting rings 130 have panel mounting plates 132 positioned around the ring 130 that define holes and U-clips 134 for attaching to the concealment panels 52a and 52b of the radome housing 50. As described in more detail above, the radome housing 50 includes a plurality of substantially identical concealment panels 52. Each panel 52 has a recessed edge 54 with through holes 55 and has an overlap edge 56 with slotted holes 57. Each panel 52 also has slotted mounting holes 53 on both ends. One panel 52b is attached to the mounting plates 132 of the mounting rings 130 using metal fasteners 59 positioned in the slotted mounting holes 53 of the panel 52b and threaded into the U-clips 134 in the mounting plates 132. The other panel 52a is similarly attached to the mounting plates 132, and the seams formed between the adjoining recessed and overlap edges 54 and 56 are connected by plastic fasteners 58. Accordingly, any cables and/or antennas (not shown) can be concealed and protected within the radome housing 50. Furthermore, the radome housing 50 according to the teachings of the present disclosure provides substantial electromagnetic radiation transparency, as described above.

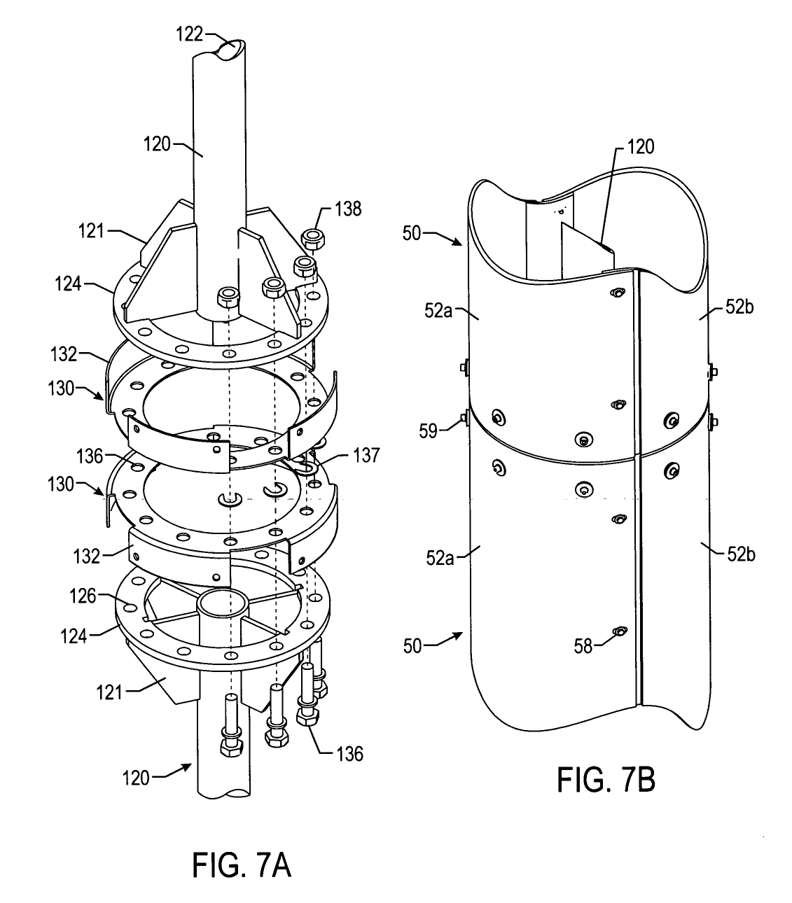

Referring to FIGS. 7A and 7B, the attachment of more than one mounting spool 120 and radome housing 50 is illustrated for flag pole structures requiring numerous antennas or greater height. In FIG. 7A, two mounting spools 120 to be mounted one on top of the other are shown in an exploded view. Two mounting rings 130 are sandwiched between adjacent flanges 124 on the mounting spools 120. Holes 136 in the mounting rings 130 are aligned with holes 126 in the flanges 124, and the mounting plates 132 on the adjoining rings 130 are also aligned. Bolts 136 are passed through the holes 126 and 136, and nuts 138 are torque wrench tightened thereon to connect the mounting spools 120. In addition, washers are preferably used, and horseshoe shims 137 are prefrably positioned between the adjoining mounting rings 130, if required. As best shown in FIG. 7B, pairs of concealment panels 52a and 52b can be connected to each section of the assembly using fasteners 58 and 59 to form adjacent and connected radome housings 50 for the flag pole structure.

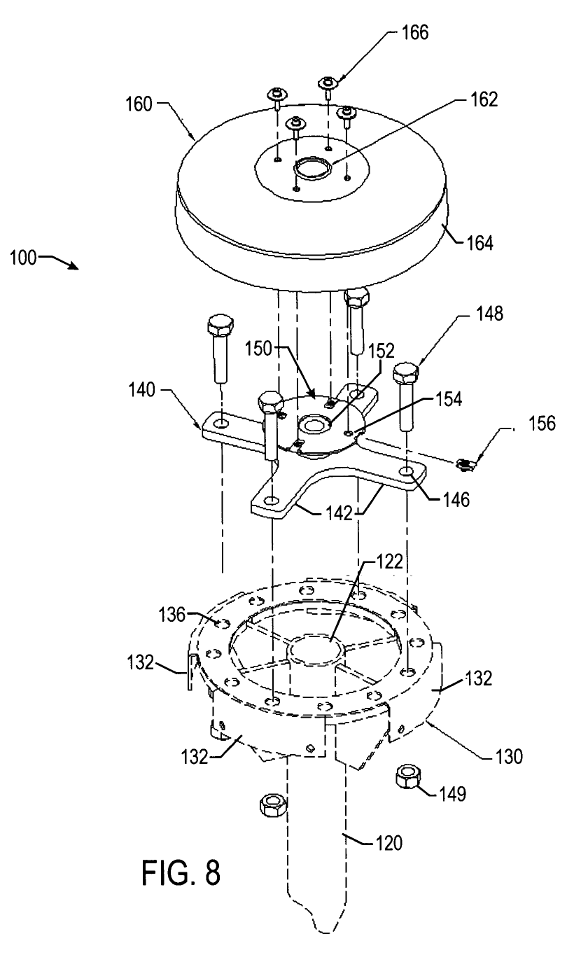

Referring to FIG. 8, components at the top of the flag pole structure 100 are illustrated in an exploded view. The flange 124 of a last mounting spool 120 of the flag pole structure 100 is shown with a mounting ring 130 positioned thereon. Before any concealment panels (not shown) of a radome housing are attached to the last spool 120, a cap adapter 140 is mounted on the mounting ring 130 and flange 124. The cap adapter 140 is preferably composed of steel. The cap adapter 140 has four wings 142 with holes 146 and attaches to the aligned holes in the ring 130 and flange 124 using bolts 148 and nuts 149. The cap adapter 140 also has a central mounting plate 150 that extends beyond the wings 142 and has a central threaded opening 152. Holes 154 and indentations are formed around the periphery of the central mounting plate 150, and U-clips 156 are positioned at each of the holes 154 and indentations. Once the concealment panels (not shown) are attached to the mounting spool 120 as described previously, the cap 160 fits over the cap adapter 140. The cap 160 is preferably composed of PVC that has been thermoformed. Preferably, the cap 160 has a rim 164 that overlaps the ends of the concealment panels. The cap 160 has a cap plug 162 about 2.5-inches in diameter and attaches to the mounting plate 150 with fasteners 166 that mate with the U-clips 156 on the central mounting plate 150.

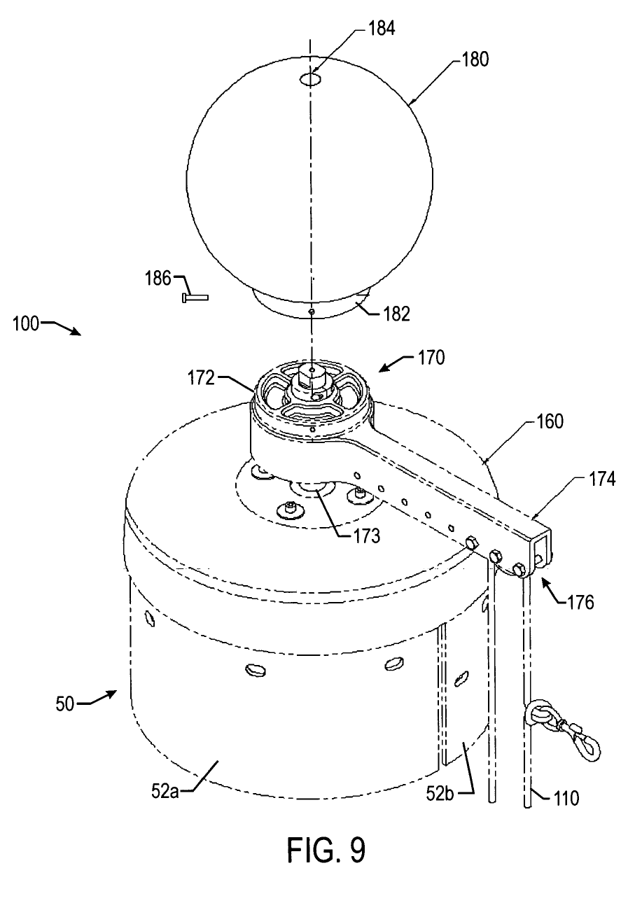

As best shown in FIG. 9, the top of the flag pole structure 100 is illustrated in a partially assembled view. As noted above, the cap 160 can have a cap plug (162 in FIG. 8). If the structure is to be used as a flagpole, the plug is removed and the flag truck assembly 170 is mounted on the cap 160. The flag truck assembly 170 includes a head 172, a shaft, and an arm 174. The head 172 includes a bearings or the like and is rotatably mounted about the shaft 173. One end of the shaft 173 installs through the opening in the cap 160 and threads into the threaded opening (152 of the central mounting plate 150 of FIG. 8). The arm 174 is preferably bifurcate and has a pulley or wheel 176 positioned therein. The position of the pulley 176 can be adjusted along the length of the arm 174 depending on the diameter of the flagpole structure 100. A plurality of adjustment holes are provided along the length of the arm 174 for that purpose. The halyard rope 110 is passed over the pulley 176. In FIG. 9, the ball 180, which can be composed of fiberglass, has an end 182 that attaches with fasteners 183 to another end of the shaft 173 extending beyond the head 172 of the flag truck assembly 170. For the flag pole structure 100 having diameters greater 28-inches, an extension with pulley can be attached to the arm 174 using the adjustment holes along the length of the arm. Depending on grounding preferences, a ground cable for lightning can be attached to the truck 170, the ball 180, or other component.

The foregoing description of preferred and other embodiments is not intended to limit or restrict the scope or applicability of the inventive concepts conceived of by the Applicant or defined in the appended claims. In exchange for disclosing the inventive concepts contained herein, the Applicant desires all patent rights afforded by the appended claims. It is intended that the inventive concepts defined by the appended claims include all modifications and alterations to the full extent that such modifications or alterations come within the scope of the appended claims or the equivalents thereof.

What is claimed is:

1. A structure for a telecommunication antenna, comprising:
a concealment panel, the concealment panel comprising a foam core having a low-dielectric constant expanded poly-vinyl-chloride foam sheet disposed on at least one surface of the foam core.

2. The structure of claim 1, further comprising means for mechanically interlocking together ends of the concealment panels.

3. The structure of claim 1, wherein the foam core comprises polystyrene.

4. The structure of claim 1, wherein the foam core has first and second sides, and wherein a first low-dielectric constant expanded poly-vinyl-chloride foam sheet is disposed on the first side and a second low-dielectric constant expanded poly-vinyl-chloride foam sheet is disposed on the second side.

5. The structure of claim 4, wherein the form core forms a tongue portion along one edge of the panel, and wherein the first and second low-dielectric constant expanded poly-vinyl-chloride foam sheets form a groove portion along another edge of the panel.

6. The structure of claim 1, wherein the low-dielectric constant expanded poly-vinyl-chloride foam sheet is attached on the at least one surface of the foam core by an adhesive or a tape.

7. The structure of claim 6, wherein the adhesive comprises urethane forming a layer between the low-dielectric constant expanded poly-vinyl-chloride foam sheet and the foam core and having a thickness of approximately 3 to 10-mils.

8. The structure of claim 1, wherein the low-dielectric constant expanded poly-vinyl-chloride foam sheet has a dielectric constant equal to or less than two.

9. The structure of claim 1, wherein the low-dielectric constant expanded poly-vinyl-chloride foam sheet has a thickness of approximately 4 to 10-mm, and wherein the foam core has a thickness of approximately 2-inches.

10. A structure for a telecommunication antenna, comprising:
a plurality of concealment panels for concealing a portion of the antenna, the concealment panels at least partially composed of an expanded poly-vinyl-chloride foam having a dielectric constant equal to or less than two.

11. The structure of claim 10, further comprising means for mechanically interlocking together ends of the concealment panels.

12. The structure of claim 10, wherein the panels comprise a first sheet of expanded polyvinyl-chloride foam.

13. The structure of claim 12, wherein the panels comprise a foam core disposed on a side of the first sheet of expanded poly-vinyl-chloride foam.

14. The structure of claim 13, wherein the foam core comprises polystyrene.

15. The structure of claim 13, wherein the panels further comprise a second sheet of expanded poly-vinyl-chloride foam disposed on side of form core opposing the first sheet.

16. The structure of claim 10, wherein the foam core is attached to the first sheet of expanded poly-vinyl-chloride foam by an adhesive or a tape.

17. The structure of claim 10, wherein the concealment panels define curved surfaces by thermoforming or vacuum forming a substantially flat sheet.

18. The structure of claim 17, wherein the panels with the curved surfaces have a smaller thickness at edges of the panels than at a center of the panels.

19. A structure for a telecommunication antenna and for a flag with a rope, the structure having a mounting spool with a flange, comprising:
a plurality of concealment panels;
a mounting ring connecting to the flange;
means for mechanically connecting the concealment panels on the mounting ring;
an adapter coupling to the mounting ring and flange and having a mounting plate, the mounting plate extending beyond the flange and defining a first opening;
a cap coupling to the mounting plate and defining a second opening;
a truck including a shaft and an arm, the shaft installing in the second opening of the cap and coupling to the first opening of the adapter, the arm rotatable about the shaft and having the rope for the flag connected thereto.

20. The structure of claim 19, wherein the concealment panels are at least partially composed of an expanded poly-vinyl-chloride foam having a dielectric constant equal to or less than two.

21. The structure of claim 19, wherein the adapter includes a plurality of wings coupling to the flange with fasteners and having the mounting plate extending from substantially in a center of the wings.

22. The structure of claim 19, wherein the cap includes a rim fitting over an edge of the flange and over ends of the concealment panels.

23. The structure of claim 19, wherein the cap couples to the mounting plate with a plurality of fasteners installed in holes in the cap and the mounting plate.

24. The structure of claim 19, wherein the truck includes head integrally connected to the arm and having the shaft positioned therethrough, the head having bearings for rotating about the shaft.

25. The structure of claim 19, wherein the arm of the truck includes a pulley to which the rope for the flag is connected.

26. The structure of claim 25, wherein the pulley is adjustable along a length of the arm.
